(19) United States
(12) Patent Application Publication
(10) Pub. No.: US 2012/0229492 A1
(43) Pub. Date: Sep. 13, 2012

(54) Projecting Method and Mobile Device Thereof

(76) Inventors: Shang-Shian Chen, Taoyuan County (TW); Cheng-Chung Lee, Taoyuan County (TW); Yun-Fei Wei, Taoyuan County (TW); Szu-Han Wu, Taoyuan County (TW)

(21) Appl. No.: 13/228,463

(22) Filed: Sep. 9, 2011

Related U.S. Application Data
(60) Provisional application No. 61/391,688, filed on Oct. 11, 2010.

(51) Int. Cl. G09G 5/02; G09G 5/00

(52) U.S. Cl. 345/589

(57) ABSTRACT

The present invention discloses a projecting method from a mobile device to an on-board unit (OBU). The projection method includes steps of storing a first display frame data with a first resolution and a first color format of the OBU in a first writeback buffer; transferring the first display frame data to an OBU display; and displaying the first display frame data in the OBU display.

### CROSS REFERENCE TO RELATED APPLICATIONS

This application claims the benefit of U.S. Provisional Application No. 61/391,688, filed on Oct. 11, 2010 and entitled “HTC Mode between OBU and the mobile device”, the contents of which are incorporated herein by reference.

### BACKGROUND OF THE INVENTION

1. Field of the Invention

The present invention relates to a projecting method and mobile device thereof, and more particularly, to a projecting method and mobile device thereof capable of reducing the transfer data rate and achieving better quality and performance.

2. Description of the Prior Art

Formerly, an on-board unit (OBU) in the automobile only has very simplified functionality, such as FM/AM channel or CD player. Nowadays, with consumer electronics technology rapidly advancing/growing up, if a mobile device, such as a mobile phone, a personal digital assistant (PDA) or a tablet computer, is well-considered/connected together with an OBU, there will be many use cases or scenarios which could enrich user experience of automotive driver/passengers.

Thus, it is a goal to improve functionality of the OBU in the industry.

### SUMMARY OF THE INVENTION

It is therefore an objective of the present invention to provide a projecting method and mobile device thereof capable of reducing the transfer data rate and achieving better quality and performance.

The present invention discloses a projecting method from a mobile device to an on-board unit (OBU). The projection method includes steps of storing a first display frame data with a first resolution and a first color format of an OBU display in a first writeback buffer; transferring the first display frame data to the OBU; and displaying the first display frame data in the OBU display.

The present invention further discloses a mobile device for projecting display contents to an on-board unit (OBU). The mobile device includes a first writeback buffer, for transferring a first display frame data to the OBU; and a first mixer, for storing the first display frame data with a first resolution and a first color format of an OBU display in the first writeback buffer; wherein the OBU display displays the first display frame data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an operational process between an on-board unit (OBU) and a mobile device according to an embodiment of the present invention.

FIG. 2 is a schematic diagram of a projecting process from a mobile device to an OBU according to an embodiment of the present invention.

FIG. 3 is a schematic diagram of a mobile device according to an embodiment of the present invention.

FIG. 4 is a schematic diagram of a mobile device according to another embodiment of the present invention.

FIG. 5 is a schematic diagram of an OBU according to an embodiment of the present invention.

### DETAILED DESCRIPTION

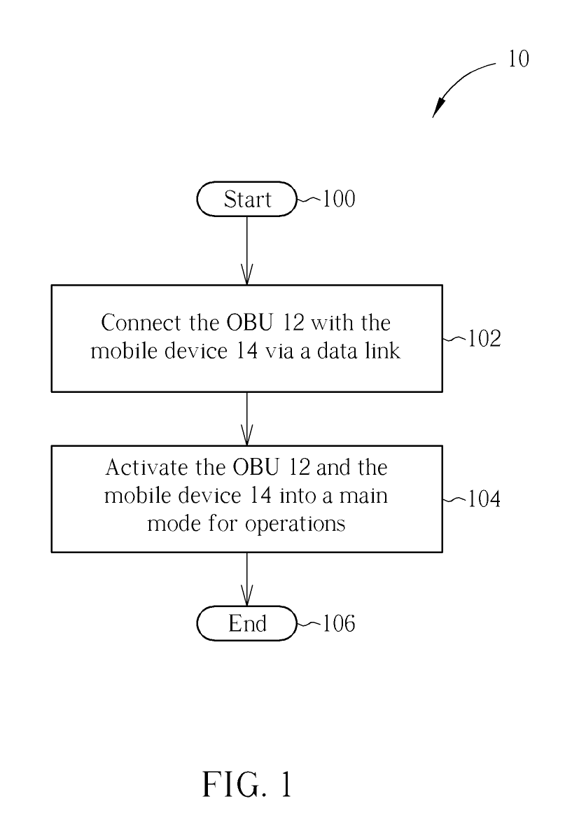

Please refer to FIG. 1, which is a schematic diagram of an operational process 10 between an on-board unit (OBU) 12 and a mobile device 14 according to an embodiment of the present invention, wherein the mobile device 14 can be a mobile phone, a personal digital assistant (PDA), a tablet computer, etc. The operational process 10 includes the following steps:

Step 100: Start.

Step 102: Connect the OBU 12 with the mobile device 14 via a data link.

Step 104: Activate the OBU 12 and the mobile device 14 into a main mode for operations.

Step 106: End.

According to the operational process 10, after connecting the OBU 12 with the mobile device 14 via a data link such as a wireless data link or a wired data link, the OBU 12, the mobile device 14 and the data link can be considered as an OBU system, and both the OBU 12 and the mobile device 14 can be activated into a main mode for operations through a button or touch screen on the OBU 12 or the mobile device 14. The main mode further includes a projector mode, a mass storage mode, and an internet sharing mode for different operational user scenarios and the capabilities of the OBU 12 and the mobile device 14, wherein at least one of the projector mode, the mass storage mode, and the internet sharing mode can be enabled to achieve respective merits. As a result, the present invention can extend functionality of the OBU 12 by connecting the OBU 12 with the mobile device 14 via the data link.

For example, when the projector mode is enabled via the OBU 12, the OBU 12 behaves as a projector for displaying display contents of the mobile device 14 by receiving the display contents via a wired/wireless data link, wherein the display contents of the mobile device 14 displayed on the OBU 12 can be cropped or full screen. Besides, the mobile device 14 can be accessed via accessing a touch panel or input buttons of the OBU 12, so as to utilize various programs and applications of the mobile device 14 via the OBU 12. Under such a situation, the OBU 12 behaves as an input/output device for the mobile device 14. As a result, a driver or a passenger can access the programs and the applications of the mobile device 14 from the OBU 12, and key events or touch events on the OBU 12 is delivered to the mobile device 14 through remote control or remote desktop mechanisms, so as to extend functionality of the OBU 12 by utilizing the programs and the applications of the mobile device 14.

Under such a situation, since display resolution of the mobile device 14 may be many types, e.g. wide Video Graphics Array (WVGA) of 800*480 and QHD of 960*540, while display resolution of an OBU display of the OBU 12 may be lower than that of the mobile device 14, if the mobile device 14 directly transfers display frame data with a same resolution and a same color format of a mobile device display, the mobile device 14 needs to transfer too much unnecessary display frame data and the OBU 12 needs to down-scale the transferred display frame data.

For example, if the mobile device display of the mobile device 14 has a resolution of 960*540 and a color format of RGB 888, i.e. 3 bytes, and the OBU display of the OBU 12 has a resolution of 800*480 and a color format of RGB 565, i.e. 2 bytes, the mobile device 14 needs to transfer display frame data of 960*540*3 bytes, and the OBU 12 needs to down-scale the transferred display frame data to 800*480*2 bytes, which transfer too much unnecessary display frame data.

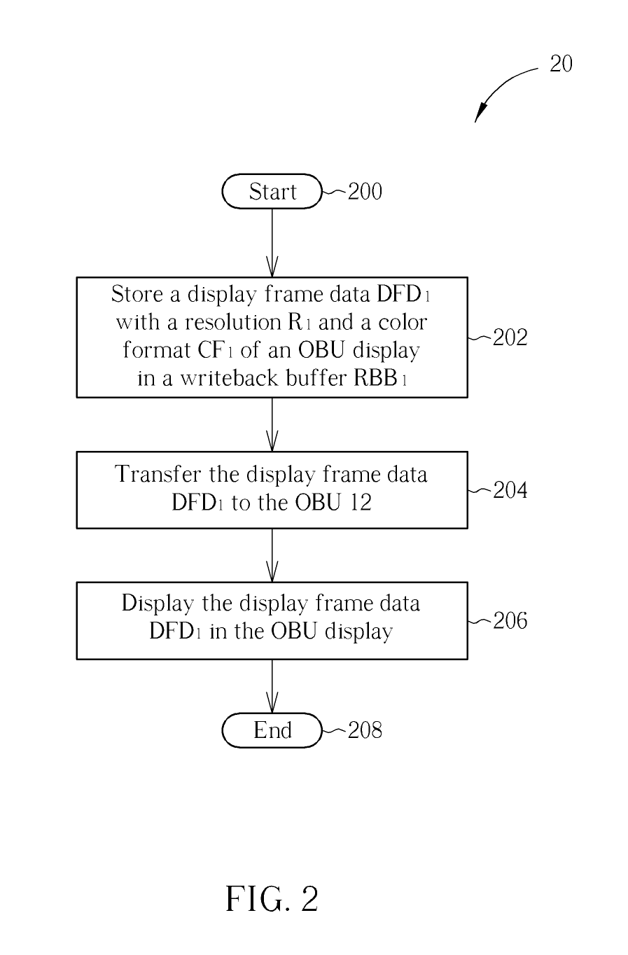

Therefore, in order to reduce a transfer data rate, please refer to FIG. 2, which is a schematic diagram of a projecting process 20 from the mobile device 14 to the OBU 12 according to an embodiment of the present invention. The projecting process 20 includes the following steps:

Step 200: Start.

Step 202: Store a display frame data DFD₁ with a resolution R₁ and a color format CF₁ of an OBU display in a writeback buffer RBB₁.

Step 204: Transfer the display frame data DFD₁ to the OBU 12.

Step 206: Display the display frame data DFD₁ in the OBU display.

Step 208: End.

According to the projecting process 20, the mobile device 14 stores the display frame data DFD₁ with the resolution R₁ and the color format CF₁ of the OBU display in the writeback buffer RBB₁, and then transfers the display frame data DFD₁ to the OBU 12. Afterwards, the OBU 12 can display the display frame data DFD₁ in the OBU display. In other words, the mobile device 14 performs video conversion process, to transfer the display frame data DFD₁ with the resolution R₁ and the color format CF₁ of the OBU display to the OBU 12 rather than a resolution R₂ and a color format CF₂ of a mobile device display.

Under such a situation, the mobile device 14 does not transfer unnecessary display frame data. Besides, since a product life cycle of the OBU 12 is longer than the mobile device 14 and the OBU 12 does not need to down-scale the transferred display frame data for display, a user can use a new mobile device 14 to connect to a old OBU 12 while higher resolution and color format of the new mobile device 14 can be converted to the OBU 12 by the same performance. Moreover, since system on chip (SoC) vendors can support a writeback mode, in which display frame data is stored in a writeback buffer with a defined resolution and color format, by a Digital Signal Processor (DSP) or a read-only memory (ROM) code process, the present invention does not waste too much CPU loading and can be controlled by a display driver of the mobile device 14. Furthermore, the writeback mode can set many types of the resolutions and color format at the running time, so as to fit any display type of the OBU 12. As a result, the present invention can reduce the transfer data rate and achieve better quality and performance.

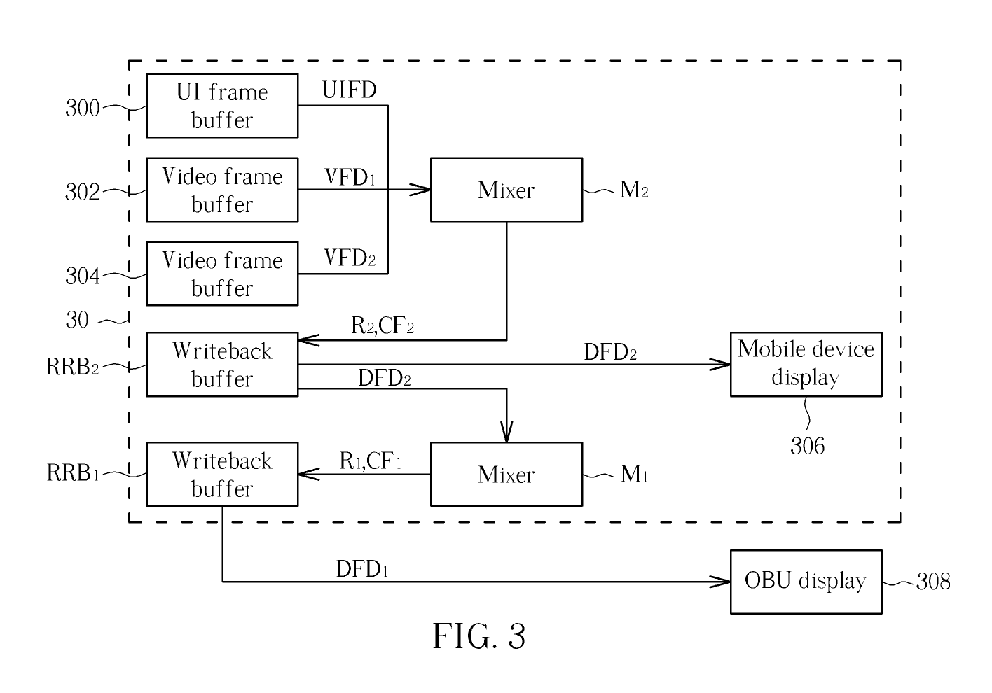

Specifically, in one embodiment, please refer to FIG. 3, which is a schematic diagram of a mobile device 30 for implementing the mobile device 14 according to an embodiment of the present invention. As shown in FIG. 3, the mobile device 30 includes an user interface (UI) frame buffer 300, video frame buffers 302, 304, mixers M₁, M₂, writeback buffers RBB₁, RBB₂, and a mobile device display 306.

In detail, the UI frame buffer 300 and the video frame buffers 302, 304 provide UI frame data UIFD and video frame data VFD₁, VFD₂ for the mixer M₂, respectively, wherein the UI frame data UIFD has a same resolution as the resolution R₂ of the mobile device display 306 and the video frame data VFD₁, VFD₂ may have a resolution equal to or less than the resolution R₂ of the mobile device display 306, i.e. cropped or filled a full screen. The mixer M₂ mixes the UI frame data UIFD and video frame data VFD₁, VFD₂ into a display frame data DFD₂, and storing the display frame data DFD₂ with the resolution R₂ and the color format CF₂ of the mobile device display 306 in the writeback buffer RBB₂. The mixer M₁ stores the display frame data DFD₁ with the resolution R₁ and the color format CF₁ of an OBU display 308 in the writeback buffer RBB₁ according to the display frame data DFD₂. The mobile device display 306 displays the display frame data DFD₂ with the resolution R₂ and the color format CF₂. The OBU display 308 displays the display frame data DFD₁ with the resolution R₁ and the color format CF₁. Under such a situation, the writeback buffers RBB₁, RBB₂ are utilized for providing the display frame data DFD₁ with the resolution R₁ and the color format CF₁ and the display frame data DFD₂ with the resolution R₂ and the color format CF₂ for the OBU display 308 and the mobile device display 306, respectively. As a result, both the mobile device display 306 and the OBU display 308 display contents of the mobile device 30.

However, since the mobile device 30 includes the two writeback buffers RBB₁, RBB₂ for displaying contents in both the mobile device display 306 and the OBU display 308, the mobile device 30 has latency and higher cost due to two writeback processing.

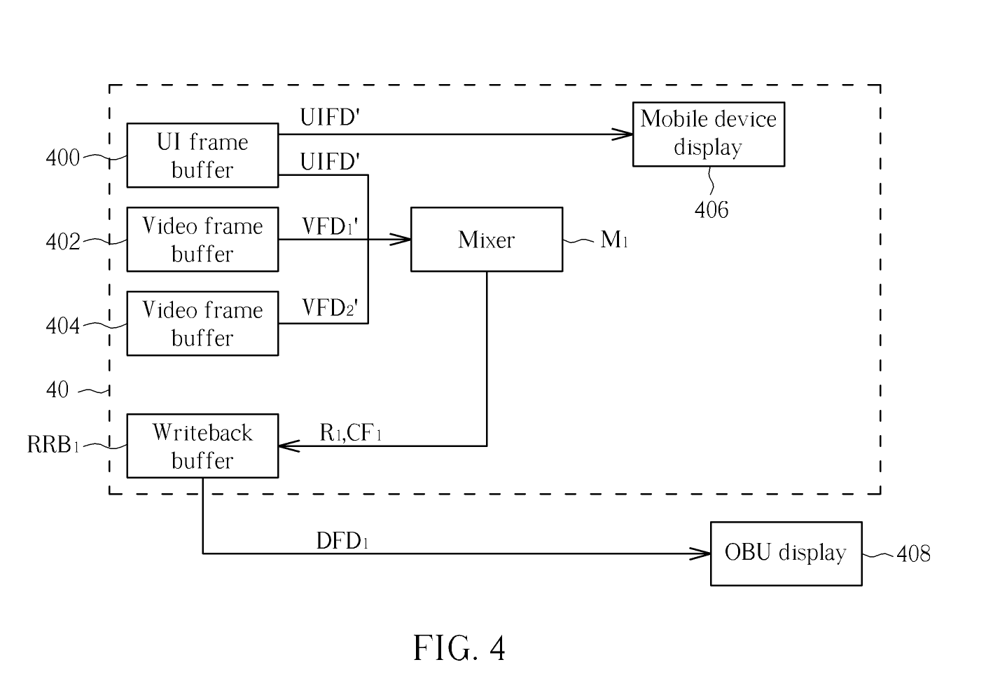

On the other hand, in another embodiment, please refer to FIG. 4, which is a schematic diagram of a mobile device 40 for implementing the mobile device 14 according to an embodiment of the present invention. As shown in FIG. 4, the mobile device 30 includes an UI frame buffer 400, video frame buffers 402, 404, a mixer M₁, a writeback buffer RBB₁, and a mobile device display 406.

In detail, the UI frame buffer 400 provides UI frame data UIFD′ for the mobile device display 406 and the mixer M₂, and the video frame buffers 402, 404 provide video frame data VFD₁′, VFD₂′ for the mixer M₂, wherein the UI frame data UIFD′ has a same resolution as the resolution R₂ of the mobile device display 406 and the video frame data VFD₁′, VFD₂′ may have a resolution equal to or less than the resolution R₂ of the mobile device display 406, i.e. cropped or filled a full screen. The mixer M₁ mixes the UI frame data UIFD′ and video frame data VFD₁′, VFD₂′ into the display frame data DFD₁, and storing the display frame data DFD₁ with the resolution R₁ and the color format CF₁ of an OBU display 408 in the writeback buffer RBB₁. The mobile device display 406 displays the UI frame data UIFD′ with the resolution R₂ and the color format CF₂. The OBU display 408 displays the display frame data DFD₁ with the resolution R₁ and the color format CF₁. Under such a situation, the writeback buffer RBB₁ is utilized for providing the display frame data DFD₁ with the resolution R₁ and the color format CF₁ for the OBU display 408. As a result, the mobile device display 306 only displays the UI frame data UIFD′ while the OBU display 308 displays contents of the mobile device 40, such that the mobile device 40 has less system loading and cost compared with the mobile device 30.

Noticeably, the spirit of the present invention is to convert display frame data with the resolution R₁ and the color format CF₁ of the OBU display in the mobile device 14, such that the mobile device 14 does not transfer unnecessary display frame data and the OBU 12 does not need to down-scale the transferred display frame data for display, so as to reduce the transfer data rate and achieve better quality and performance. Those skilled in the art should make modifications or alterations accordingly. For example, in the above embodiments, only two video frame buffers are illustrated as example. However, the display frame data can comprise an UI frame data or at lest one video frame data in practice.

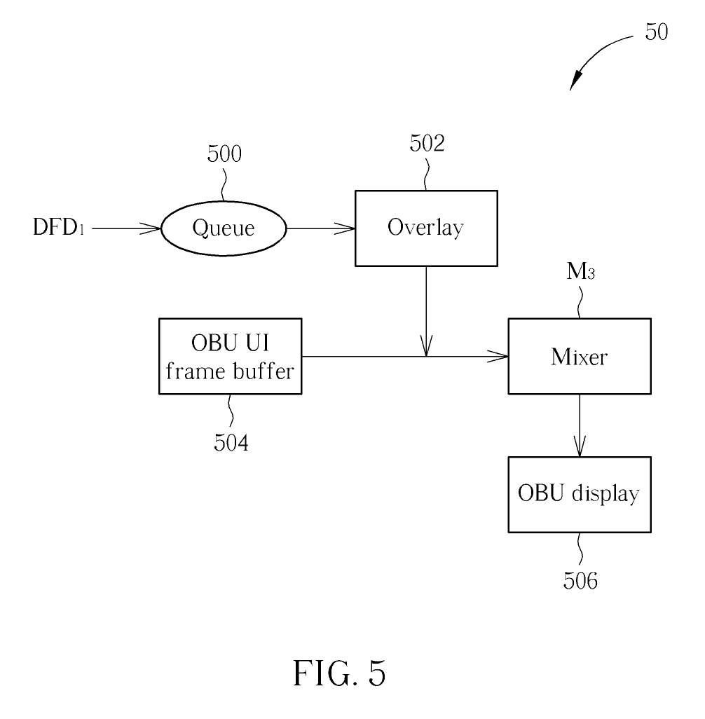

Besides, please refer to FIG. 5, which is a schematic diagram of an OBU 50 for implementing the OBU 12 according to an embodiment of the present invention. As shown in FIG. 5, the OBU 50 includes a queue 500, an overlay 502, an OBU UI frame buffer 504, a mixer M₃, and an OBU display 506.

In detail, the queue 500 receives and outputs the display frame data DFD₁ in a first-in-first-out (FIFO) manner. The overlay 502 converts the display frame data DFD₁ into a display frame data DFD₃ with a resolution R₃ and a color format CF₃ and performs rotation on the display frame data DFD₃ according to a display mode of the display frame data DFD₁. The OBU UI frame buffer 504 provides OBU UI frame data OBUUIFD with a same resolution as the resolution R₁ of the OBU display 506. The mixer M₃ mixes the display frame data DFD₃ with the OBU UI frame data OBUUIFD. The OBU display 506 displays the mixed display frame data DFD₃. Under such a situation, the display frame data DFD₁ transferred from the mobile device 14 is further handled by the OBU 50, such that the OBU 50 can resize, scale and rotate the display frame data DFD₁ according to the display mode of the display frame data DFD₁ is a portrait mode or a landscape mode. As a result, the mobile device 14 can transfer necessary display frame data with a fixed transfer data rate while the OBU 50 handles image processing according to the display mode of the transferred display frame data.

In the prior art, the conventional on-board unit (OBU) in the automobile only has very simplified functionality, such as FM/AM channel or CD player. In comparison, the present invention connects the OBU with the mobile device via the data link and activates the OBU and the mobile device into the main mode for operations, so as to extend functionality of the OBU. Besides, in the projector mode, the present invention further converts display frame data with the resolution R₁ and the color format CF₁ of the OBU display in the mobile device 14, such that the mobile device 14 does not transfer unnecessary display frame data and the OBU 12 does not need to down-scale the transferred display frame data for display, so as to reduce the transfer data rate and achieve better quality and performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projecting method from a mobile device to an on-board unit (OBU), the projection method comprising:
storing a first display frame data with a first resolution and a first color format of an OBU display in a first writeback buffer;
transferring the first display frame data to the OBU; and
displaying the first display frame data in the OBU display.

2. The projecting method of claim 1 further comprising:
mixing an user interface (UI) frame data and at least one video frame data into a second display frame data;
storing the second display frame data with a second resolution and a second color format of a mobile device display in a second writeback buffer; and
displaying the second display frame data in the mobile device display;
wherein the first display frame data is stored in the first writeback buffer according to the second display frame data.

3. The projecting method of claim 1 further comprising:
displaying an UI frame data in a mobile device display; and
mixing the UI frame data and at lest one video frame data into the first display frame data.

4. The projecting method of claim 1, wherein the step of displaying the first display frame data in the OBU display comprises:
converting the first display frame data into a third display frame data with a third resolution and a third color format and performing rotation on the third display frame data according to a display mode of the first display frame data;
mixing the third display frame data with an OBU UI frame data; and
displaying the mixed third display frame data in the OBU display.

5. The projecting method of claim 1, wherein the display mode is a portrait mode or a landscape mode.

6. A mobile device for projecting display contents to an on-board unit (OBU), the mobile device comprising:
a first writeback buffer, for transferring a first display frame data to the OBU; and
a first mixer, for storing the first display frame data with a first resolution and a first color format of an OBU display in the first writeback buffer;
wherein the OBU display displays the first display frame data.

7. The mobile device of claim 6 further comprising:
a mobile device display, for displaying a second display frame data; and
a second mixer, for mixing an user interface (UI) frame data and at lest one video frame data into a second display frame data, and storing the second display frame data with a second resolution and a second color format of the mobile device display in a second writeback buffer;
wherein the first mixer stores the first display frame data in the first writeback buffer according to the second display frame data.

8. The mobile device of claim 6 further comprising a mobile device display, for displaying an UI frame data, wherein the first mixer mixes the UI frame data and at lest one video frame data into the first display frame data.

9. The mobile device of claim 6, wherein the OBU comprises:
an overlay, for converting the first display frame data into a third display frame data with a third resolution and a third color format and performing rotation on the third display frame data according to a display mode of the first display frame data; and
a third mixer, for mixing the third display frame data with an OBU UI frame data;
wherein the OBU display displays the mixed third display frame data.

10. The mobile device of claim 6, wherein the display mode is a portrait mode or a landscape mode.
